(19) United States
(12) Patent Application Publication
(10) Pub. No.: US 2009/0319131 A1
(43) Pub. Date: Dec. 24, 2009

(54) VEHICLE MACRO RECORDING AND PLAYBACK SYSTEM ABLE TO OPERATE ACROSS SUBSYSTEM BOUNDARIES

(75) Inventors: Timothy M. Burns, DURHAM, NC (US); Curtiss J. Howard, RALEIGH, NC (US); Stephen J. Kenna, CARY, NC (US); Maxim A. Moldenhauer, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/145,309

(22) Filed: Jun. 24, 2008

(51) Int. Cl. G06F 17/00

(52) U.S. Cl. 701/48; 701/36; 701/213

(57) ABSTRACT

An in-vehicle macro system can include a bus connecting a volatile memory, a non-volatile storage medium, and a processor. The non-volatile memory can include a set of macros and a set of computer program products including instructions which the processor is configured to execute. The computer program products can include a macro playback component and a macro recorder. The macros can each include a linkage to a set of associated actions. Each of the actions can control an adjustable setting of a vehicle subsystem, wherein actions associated with a single macro are able to control settings of different vehicle subsystems. The macro playback component can execute the macros, where execution of each macro causes the actions associated with the macro to be performed. The macro recorder can be used to create new macros. Each newly established macro can include a set of user specified actions.

### BACKGROUND OF THE INVENTION

The present invention relates to the field of macros for motorized vehicles, more particularly, to a vehicle macro recording and playback system having context dependent vehicle macros. The macro system can also operate across subsystem boundaries, thereby being a unified system for manipulating all intra-vehicle controls.

Vehicle interiors are becoming increasingly sophisticated and an array of user-adjustable, in-vehicle controls are escalating. In vehicle controls can include, but are not limit to, stereo system controls, window controls, seat adjustment controls, internal temperature controls, navigation control, communication system controls, media playback controls, song list controls, and the like. Presently, vehicle occupants can spend a significant amount of time adjusting these vehicle controls to suit their preferences. This can become frustrating when two or more people, who have different preferred control settings, share a use of a vehicle.

Some vehicles include a few discrete subsystems that permit variable control settings to be stored in a subsystem “memory.” For example, a radio can permit a user to record a number of preset stations; an electronic seat adjuster can include multiple different memory settings for different users; a mirror adjustor can include memory settings for mirror position, which can even be linked to seat position, a seat adjustment memory in some implementations; and the like. Unfortunately, all of these memory controlled settings are discrete settings/capabilities of vehicle subsystems that are unable to be controlled across subsystem boundaries. There is currently no known method or system for permitting a vehicle occupant to record a series of control adjustments as a “macro,” which can be replayed in the future that applies to all vehicle controls (e.g., can function across subsystem boundaries).

### BRIEF DESCRIPTION OF THE SEVERAL VIEWS OF THE DRAWINGS

FIG. 1 is a schematic diagram of a vehicle having a control management system that permits configurable macros to be used to control actions of multiple vehicle subsystems.

FIG. 2 shows a macro example and a sample in-vehicle macro interface in accordance with an embodiment of the inventive arrangements disclosed herein.

FIG. 3 shows sample macros to illustrate those in-vehicle macros can include sequential steps, parallel steps, and a mixture of the two.

FIG. 4 shows flow charts for recording macros in accordance with an embodiment of the inventive arrangements disclosed herein.

### DETAILED DESCRIPTION OF THE INVENTION

The present invention discloses a unified in-vehicle macro system able to record and playback macros that adjust settings across subsystem boundaries. That is, single, centrally controlled macro system can be used to detect and adjust settings of a variety of controls, such as client control, stereo system, navigation, windows, seat positions, media playback settings, etc. In one embodiment, macros can be nested to include other macros. In one embodiment, macro recording can place the vehicle in an observation mode where all actions taken are recorded as part of a new macro. Macros can optionally include configurable time delays between consecutive actions. Macro actions can be configured to execute in serial and/or in parallel with one another.

Further, the unified in-vehicle macro system can permit different conditions to be associated with macros, which can be configured to respond in a variable fashion depending upon a state of the variable conditions. Variable conditions can include, for example, a physical location of the vehicle (i.e., determined by a GPS subsystem), a vehicle user (i.e., determined from a biometric input, a user-specific key, etc.), an outside weather condition, a time of day, and the like. To illustrate, a macro can be established for “John driving home from work” that is activated only when a driver is a John, when a driving origination location is work, and when a time of driving is between four and six p.m. on a weekday.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

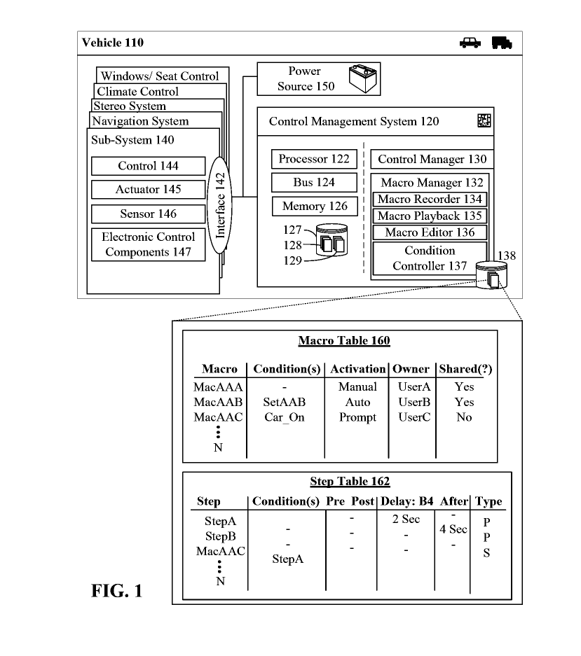

FIG. 1 is a schematic diagram of a vehicle 110 having a control management system 120 that permits configurable macros to be used to control actions of multiple vehicle subsystems 140. The vehicle 110 can include any of a variety of motorized vehicle able to transport one or more people, such as an automobile, a truck, a van, a motorcycle, and the like. The subsystems 140 and the control management system 120 can be electronically coupled to one or more power sources 150 (e.g., a vehicle battery or a battery dedicated to the component 120, 140), which satisfies the power needs of each component 120, 140.

Each of the subsystems 140 can control a configurable vehicle option. Subsystems 140 can include, for example, a navigation system, a stereo system, a climate control system, window/seat controls, media player controls, telephony system controls, and the like. A Subsystem 140 can include one or more control 144, which a user can utilize to change a settings of the subsystem. Controls 144 can include buttons, dials, knobs, graphical user interface (GUI) controls, text user interface (TUI) controls, voice user interface (VUI) controls, and the like. The controls 144 can be coupled to electronic control components 147. These components 147 map a user selection to an action to be taken, which is expressed to corresponding subsystem 140 elements. For example, a window 144 control can be a toggle button coupled to the electronic control components 147, which are linked to an actuator 145 that raises and lowers a window (performs an action) responsive to a suitable command issued by one of the electronic control components 147.

The subsystems 140 can also include one or more sensors 146 that determine a current condition of the subsystem 140, the vehicle 110, or a condition of an environment about the vehicle 110. Sensors 146 can include, but are not limited to, positioning sensors, accelerometers, velocity sensors, pressure sensors, temperature sensors, fluid level sensors, motion sensors, sound pressure level sensors, biometric sensors, and the like. A global positioning system (GPS) component that determines a vehicle 110 position can be considered a positioning sensor. In one embodiment, the vehicle 100 can include a wireless transceiver able to send/receive data to/from a network. Data received from the network can be used as state/condition determining data for purposes of macro interactions.

The subsystem 140 can exchange data (e.g., send sensor data, receive or control commands, etc.) with the control management system 120. For example, the electronic control components 147 can convey carrier wave signals, which optionally include encoded data, with system 120 via subsystem specific interface 142. The interface 142 can be an interface of the subsystem 140 configured to communicate with system 120, can be an interface of system 120 configured to communicate with a specific subsystem 140, and/or can be a proxy that reformats signals from/to the components 140, 120 so that data exchanges can be properly understood. Use of one or more interfaces 142 permits subsystem specific format considerations to be abstracted so that control manager 130 can utilize standardized communications that are independent of particular subsystem 140 specifics.

Two views of the control management system 120 are shown, a physical view and a functional one. In the physical view, the control management system 120 can include a processor 122, a volatile memory 126, and a persistent memory 127, each connected to the other via bus 124. The persistent memory 127 can include executable computer program products 128 and digitally encoded data 129.

The functional view of system 120 shows a control manager 130, a macro manager 132 and a data store 138. The control manager 130 can be configured to communicate with the subsystems 140. That is, control manager 130 can issue commands to change a state of the system 140, can receive data from each subsystem 140 that reflects a current state of that system 140 and can receive sensor 146 data from each subsystem 140. The control manager 130 can receive instructions from the macro manager 132, which can result in the control manager 130 performing one or more tasks, which control subsystem 140 behavior.

The macro manager 132 can be used to establish, edit, delete, and execute macros. A macro can be a configured set of one or more actions. These actions can be executed in parallel or in sequence with each other. Each of the actions can control a subsystem 140 function/ability. The macro manager 132 can include a macro recorder 134, a macro playback component 135, a macro editor 136, a condition controller 137, and/or the like. Macro specific data can be stored in data store 138.

The macro recorder 134 can record a sequence of actions relating to controlling a subsystem 140. The macro playback component 135 can cause the steps of a previously recorded macro to be executed in accordance with macro specifics. The macro editor 136 can permit changes to be made to a macro previously stored in data store 138. The condition controller 137 can determine a set of conditions, compare these conditions against a set of thresholds in accordance with programmatically specified rules, and can perform a set of actions based upon results of the comparisons. In different embodiments, the conditions handled by the controller 137 can cause a macro to execute, can prevent a macro from executing, and can prompt a user to confirm that an associated macro should be executed.

The conditions handled by controller 137 can include any programmatically definable condition. For example, one condition can be vehicle 110 location, as determined by a GPS sensor 146. Other conditions can be related to a vehicle speed, acceleration, or direction of travel, to an external/interior temperature, to an ambient noise level inside/outside the vehicle 110, to a presence and identity of vehicle occupants, etc.

Macro table 160 shows that a number of macros can be recorded within data store 138. Each macro can have an associated name or identifier, an owner, and an indicator as to whether the macro is to be shared among a set of vehicle users. Each macro can also be associated with a set of one or more conditions. These can be activation conditions to automatically activate the macro, can be restrictive conditions to prevent a macro from executing, etc. Macros can also be associated with an activation setting, which indicates a manner in which a macro is to be activated. Macros can be restricted to manual only activation, can be enabled for automatic activation (subject to occurrences of a related set of conditions), can be enabled to automatically prompt a user to active the macro, and the like.

Step table 162 can be used to define a set of steps that are associated with a specific macro. Each of these steps can include pre and post conditions, can include delays to be conducted before and after the step executes, a type of step execution, and other configurable attributes. A type of execution can refer to parallel or serial execution. Macros are permitted to be nested, so one or more of the steps for a macro can be another macro.

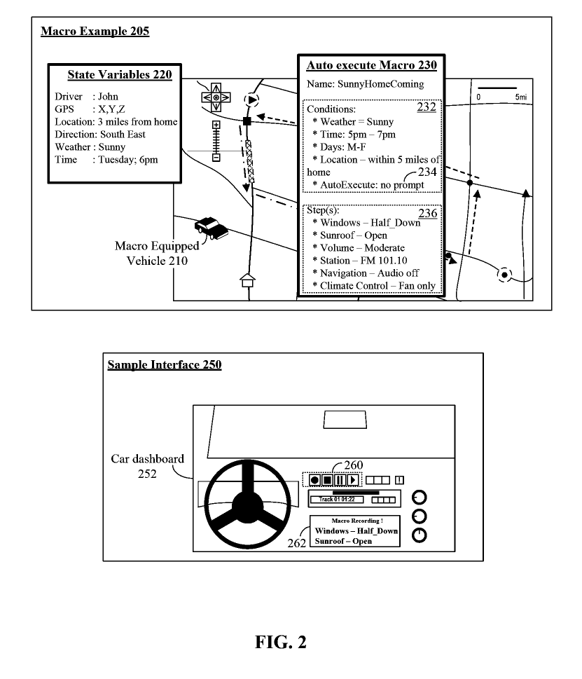

FIG. 2 shows a macro example 205 and a sample in-vehicle macro interface 250 in accordance with an embodiment of the inventive arrangements disclosed herein. The examples 205 and 250 can be performed in context of a system 100. Each of the examples 205, 250 are for illustrative purposes only and are not to be construed as a limitation of the disclosed invention.

In macro example 205, a macro equipped vehicle 210 can be traveling along a roadway. A set of state variables 220 can exist for the vehicle 210, which represents its current operating state and conditions (e.g., weather, position, etc.) detected by vehicle sensors. The vehicle 210 can include a control management system configured to handle recordation, playback, and editing of macros. One or more of the macros can be configured to automatically execute based upon an occurrence of a previously defined set of conditions, as shown by auto execute macros 230.

As shown, the state variables 220 can determine current values for a vehicle driver, GPS coordinates for the vehicle, a position of the vehicle relative to a defined landmark, a direction of travel, an external weather condition about the vehicle, a current time, and the like.

One of the auto executing macros 230, named SunnyHomeComing, can automatically execute according to previously established conditions 232 when the weather is sunny, the time is between five and seven p.m., the day of the week is between Monday and Friday, and the vehicle is within five miles from home. Steps 236 performed when the SunnyHomeComing macro executes can include: adjusting the windows to a half down position, opening the sunroof, placing a stereo volume to a moderate loudness, tuning a stereo to a specific station, turning audio of a navigation system off, and adjusting the climate control system to fan only.

It should be appreciated from example 205 that any number of static/dynamic conditions can be associated with a macro 230 so long as these conditions can be programmatically determined/ascertained by an in-vehicle system. Further, any number of configurable macro steps 236 can be performed, which span vehicle subsystems.

Sample interface 250 illustrates one way to record, play, and/or edit 260 macros from within a vehicle. One or more interface controls, such as buttons 260 can be presented within a car dashboard 252. Further, a display 262 can present information regarding macro related actions. As shown, when a record 260 button is pressed, all actions taken by a user related to controls/control adjustments can be recorded as a macro unit a stop button 260 is pressed. The controls 260 and presentation display 262 can range from simplistic to complex. In one embodiment, a voice user interface (VUI) can be implemented that accepts speech input and provides speech output for macro related actions. Further, preexisting controls can be overloaded to have macro specific functionality. For example, display 262 can be a control typically used for vehicle navigation, which can also facilitate macro based interactions.

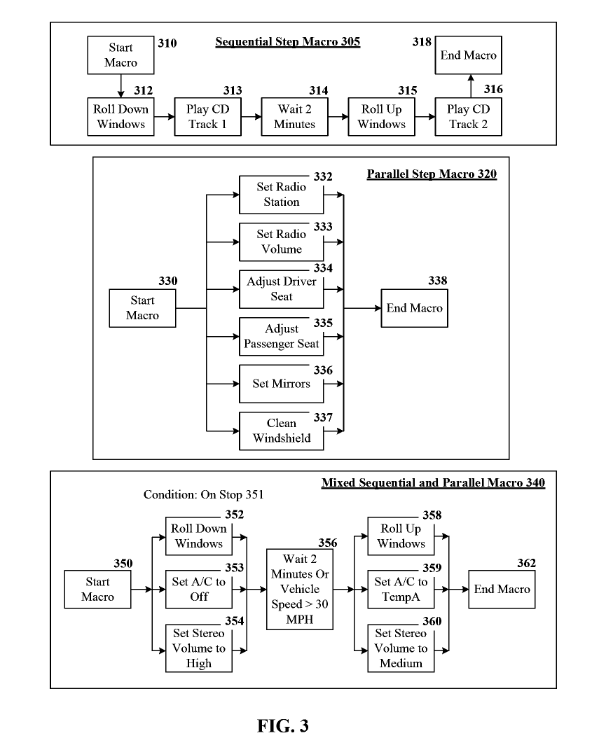

FIG. 3 shows sample macros 305, 320, 340 to illustrate that in-vehicle macros can include sequential steps, parallel steps, and a mixture of the two. The macros 305, 320, and 340 can be executed in context of a system 100.

Macro 305 shows an example of a macro executing a set of sequential actions of steps 312-316. That is, each step 312-316 starts when a preceding step stops. According to the example 305, the macro can start in step 310. In step 312, a vehicle's windows can be rolled down. In step 313, track one of an accessible compact disk (CD) can be played. In step 314, a two minute delay can occur. After the two minutes, the windows can be rolled up, as per step 315. In step 316, track two of the CD can be played, which can be the last macro action 318.

Macro 320 shows an example of a macro executing a set of parallel actions 332-337. The macro can start in step 330. Steps 332-337 can be concurrently executed/initiated. Step 332 shows a radio station being set. A radio volume can be adjusted in step 333. A driver's seat adjustment can be performed by step 334 and a passenger's seat can be adjusted by step 335. The position of vehicle mirrors can be adjusted in step 336. The windshield can be cleaned in step 337. The macro ends in step 338.

Macro 340 shows an example of a macro having some parallel and some sequential steps/actions. As shown, actions 352-354 can execute concurrently, as can actions 358-360. The example, 340 also imposes execution conditions for some of the steps.

More specifically, the macro 340 can start in step 350, execution of concurrent steps 352-354 can begin only once the vehicle stop condition 351 is satisfied (e.g., the vehicle stops a red light, stop sign, etc.). In step 352, windows of the vehicle can be rolled down. An A/C setting can be adjusted to an off position, in step 353. Stereo volume can be adjusted to a high setting in step 354. Step 356 shows that the macro 340 is to delay for two minutes unless the vehicle speed exceeds thirty miles per hour. Once either condition is satisfied, steps 358-360 are concurrently initialized.

In step 358, the windows can be rolled up. In step 359, the A/C can be turned on and set to a designated temperature (TempA). In step 360, the stereo volume can be adjusted to a medium volume. The macro can end in step 362.

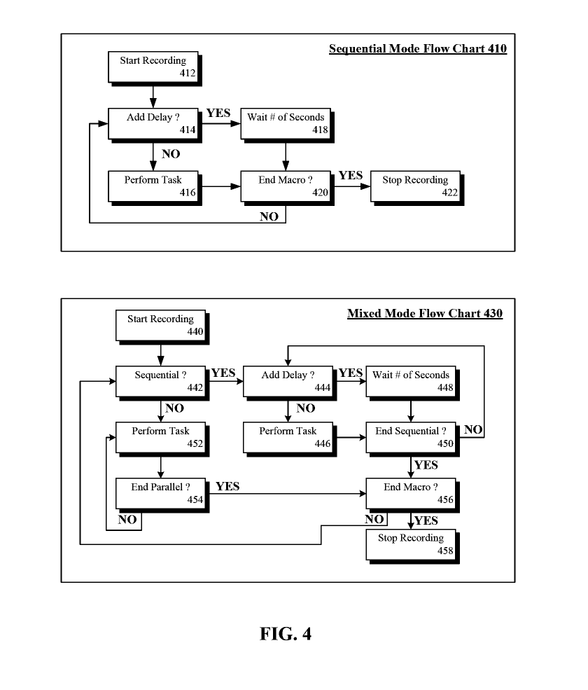

FIG. 4 shows flow charts 410, 430 for recording macros in accordance with an embodiment of the inventive arrangements disclosed herein. Each of the flow charts 410, 430 can be performed in context of system 100.

Flow chart 410 shows a sample process for recording a sequential macro. In step 412, a macro recording can be initiated. When there is a delay to be added in step 414, the process can delay for a specific number of seconds, as shown by step 418. Otherwise, step 416 can perform a task or action defined by the macro. Step 420 can check to see if the macro recording is to be ended. If not, the recording process can loop back to step 414. When the macro is to end, the recording process can stop in step 422 and subsequent actions can be taken, such as naming the macro and/or establishing conditions/constraints for activation of the macro.

One implementation of the invention permits a parallel recordation of a set of macro actions. When such a macro is recorded, no time delays are written into the macro, since all tasks associated with a recorded macro can be concurrently performed (as illustrated in macro example 320).

Flow chart 430 shows a sample process for recording a mixed mode macro, which is one having some actions to be performed in parallel and other actions to be performed in series. In step 440, a recording process for a macro can begin. A check to see if subsequent steps are to be parallel or serial steps can be made in step 442. If serial, a delay can be checked for in step 444. When there is to be a delay, the delay can be specified in step 448. Otherwise, a task to be included in the macro is captured in step 446. Further sequential actions can be checked for in step 450. When additional sequential actions exist, the process can loop from step 450 to step 444.

When actions are to be executed in parallel for the macro, as determined by step 442, a task to be added to the macro can be captured in step 452. The process continues to capture tasks to be executed in parallel (shown by looping from step 454 to step 452) until parallel recordation ends.

After either sequential or parallel recordation ends, the process can determine if the macro recordation is finished, as shown by step 456. When not finished, the process can loop back to step 442. The macro recording can finish in step 458, where finalization actions (if any) can be performed.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An in-vehicle macro system comprising:
a bus;
a volatile memory connected to the bus;
a non-volatile storage medium connected to the bus; and
a processor connected to the bus;
said non-volatile storage medium comprising a plurality of computer program products, wherein the processor is configured to execute programmatic instructions of each of the computer program products, said computer program products comprising a macro playback component and a macro recorder, said non-volatile memory comprising a plurality of macros;
said plurality of macros each comprising a linkage to a plurality of associated actions, each of said plurality of actions controlling an adjustable setting of a vehicle subsystem, wherein actions associated with a single macro are able to control settings of a plurality of different vehicle subsystems;
said macro playback component configured to execute said macros, wherein execution of each macros causes the actions associated with the macro to be performed; and
said macro recorder configured to establish new ones of said plurality of macros, wherein each newly established macro comprises a plurality of user specified actions.

2. The system of claim 1, wherein said macros comprise at least one sequential macro, at least one parallel macro, and at least one mixed mode macro, wherein for the sequential macro each of the associated actions are sequentially executed, wherein for the parallel macro each of the associated actions are executed in parallel, wherein for the mixed mode macro a portion of the associated actions are sequentially executed and another portion of the associated action are executed in parallel, wherein the macro playback component is configured to execute sequential macros, parallel macros, and mixed mode macros, and wherein the macro recorder is configured to create sequential macros, parallel macros, and mixed mode macros.

3. The system of claim 1, wherein the macro recorder is configured to initiate a macro recording mode, wherein the computer program products are configured such that when in the macro recording mode user selections of controls associated with the vehicle subsystems are detected, translated into subsystem adjustment settings, and a related macro action to adjust the subsystem to the adjustment setting is created, wherein upon completing the macro recording mode a macro comprising said related macro action is created and stored as one of the plurality of macros.

4. The system of claim 1, wherein said subsystems comprise at least three of a climate control system, a window control system, a seat position control system, a mirror control system, a stereo system, a windshield wiper system, a vehicle lighting system, a vehicle navigation system, a media playback system, and an in-vehicle communication system.

5. The system of claim 1, wherein said computer program products further comprise:
a condition controller configured to determine at least one variable condition associated with a vehicle, wherein at least a portion of the macros are associated with a condition value, wherein at least one execution characteristic is programmatically linked to a comparison result between a variable condition and the condition value, wherein said execution characteristic is at least one of:
a characteristic that causes the associated macro to selectively auto execute depending upon the comparison result; and
a characteristic that causes an attempted execution of the associated macro be selectively disabled depending upon the comparison result.

6. The system of claim 5, wherein at least one of the variable conditions is determined based upon metrics ascertained from at least one in-vehicle sensor.

7. The system of claim 6, wherein said at least one in-vehicle sensor comprises a global positioning system (GPS) sensor able to determine a geographic position of an associated vehicle, wherein said at least one variable condition comprises a position of the vehicle.

8. The system of claim 6, wherein said at least one in-vehicle sensor comprises a biometric sensor configured to determine a biometric from a vehicle occupant, which one of said computer program products is configured use to identify an occupant of a vehicle, wherein said variable condition comprises a presence/absence of a particular person within the vehicle.

9. A method for implementing configurable macros within motor vehicles comprising:
detecting a macro execution event;
determining a macro stored within a data store associated with the macro execution event, wherein the determined macro comprises a plurality of actions, wherein each action is associated with controlling an adjustable setting of a vehicle subsystem, wherein at least a portion of the actions are user configured actions established in accordance with user defined settings; and
initiating the macro, which results in each of the actions being performed, which results in the vehicle subsystems being adjusted in accordance with the associated actions, wherein said plurality of action associated the macro are able to control settings of a plurality of different vehicle subsystems.

10. The method of claim 9, further comprising:
receiving input from at least one in-vehicle sensor;
determining a current state of a variable condition based upon said received input;
comparing the current state against at least one previously defined condition value; and
programmatically executing code associated with the macro which changes a manner in which the macro is executed based upon comparison results of the comparing.

11. The method of claim 9, wherein said subsystems comprise at least three of a climate control system, a window control system, a seat position control system, a mirror control system, a stereo system, a windshield wiper system, a vehicle lighting system, a vehicle navigation system, a media playback system, and an in-vehicle communication system.

12. The method of claim 9, wherein said data store comprises a plurality of different macros, wherein said macros comprise at least one sequential macro, at least one parallel macro, and at least one mixed mode macro, wherein for the sequential macro each of the associated actions are sequentially executed, wherein for the parallel macro each of the associated actions are executed in parallel, wherein for the mixed mode macro a portion of the associated actions are sequentially executed and another portion of the associated action are executed in parallel, wherein said method is operable and said detecting, determining, and initiating are able to be performed for a sequential macro, for a parallel macro, and for a mixed mode macro.

13. The method of claim 9, further comprising:
determining a current geographical position of a vehicle;
comparing the determined geographical position against a location specified within the macro; and
altering an execution characteristic based upon results of the comparing, wherein said execution characteristic is one of:
a characteristic that causes the associated macro to selectively auto execute depending upon comparison results; and
a characteristic that causes an attempted execution of the associated macro be selectively disabled depending upon comparison results.

14. The method of claim 9, further comprising:
determining the identity of at least one occupant of the vehicle;
comparing the determined identity against a person associated with the macro and defined within the macro; and
altering an execution characteristic based upon results of the comparing, wherein said execution characteristic is one of:
a characteristic that causes the associated macro to selectively auto execute depending upon comparison results; and
a characteristic that causes an attempted execution of the associated macro be selectively disabled depending upon comparison results.

15. A computer program product for implementing configurable macros within motor vehicles comprising:
a computer usable medium having computer usable program code embodied therewith, the computer usable program code comprising:
computer usable program code configured to detect a macro execution event;
computer usable program code configured to determine a macro stored within a data store associated with the macro execution event, wherein the determined macro comprises a plurality of actions, wherein each action is associated with controlling an adjustable setting of a vehicle subsystem, wherein at least a portion of the actions are user configured actions established in accordance with user defined settings; and
computer usable program code configured to initiate the macro, which results in each of the actions being performed, which results in the vehicle subsystems being adjusted in accordance with the associated actions, wherein said plurality of actions associated the macro are able to control settings of a plurality of different vehicle subsystems.

16. The computer program product of claim 15, further comprising:
computer usable program code configured to receive input from at least one in-vehicle sensor;
computer usable program code configured to determine a current state of a variable condition based upon said received input;
computer usable program code configured to compare the current state against at least one previously defined condition value; and
computer usable program code configured to programmatically execute code associated with the macro which changes a manner in which the macro is executed based upon comparison results of the comparing.

17. The computer program product of claim 15, wherein said subsystems comprise at least three of a climate control system, a window control system, a seat position control system, a mirror control system, a stereo system, a windshield wiper system, a vehicle lighting system, a vehicle navigation system, a media playback system, and an in-vehicle communication system.

18. The computer program product of claim 15, wherein said data store comprises a plurality of different macros, wherein said macros comprise at least one sequential macro, at least one parallel macro, and at least one mixed mode macro, wherein for the sequential macro each of the associated actions are sequentially executed, wherein for the parallel macro each of the associated actions are executed in parallel, wherein for the mixed mode macro a portion of the associated actions are sequentially executed and another portion of the associated action are executed in parallel, wherein said computer program product is operable for a sequential macro, for a parallel macro, and for a mixed mode macro.

19. The computer program product of claim 15, further comprising:
computer usable program code configured to determine a current geographical position of a vehicle;
computer usable program code configured to compare the determined geographical position against a location specified within the macro; and
computer usable program code configured to alter an execution characteristic based upon comparison results, wherein said execution characteristic is one of:
a characteristic that causes the associated macro to selectively auto execute depending upon comparison results; and
a characteristic that causes an attempted execution of the associated macro be selectively disabled depending upon comparison results.

20. The computer program product of claim 15, further comprising:
computer usable program code configured to determine an identify of at least one occupant of the vehicle;
computer usable program code configured to compare the determined identity against a person associated with the macro and defined within the macro; and
computer usable program code configured to alter an execution characteristic based upon comparison results, wherein said execution characteristic is one of:
a characteristic that causes the associated macro to selectively auto execute depending upon comparison results; and
a characteristic that causes an attempted execution of the associated macro be selectively disabled depending upon comparison results.
